(19) United States
(12) Patent Application Publication
(10) Pub. No.: US 2015/0110358 A1
(43) Pub. Date: Apr. 23, 2015

(54) APPARATUS AND METHOD FOR DETECTING VEHICLE NUMBER PLATE

(71) Applicant: Electronics and Telecommunications Research Institute, Daejeon (KR)

(72) Inventors: Byung Gil HAN, Daegu (KR); Kil Taek LIM, Daegu (KR); Yun Su CHUNG, Daegu (KR); Soo In LEE, Daejeon (KR)

(73) Assignee: Electronics and Telecommunications Research Institute, Daejeon (KR)

(21) Appl. No.: 14/254,358

(22) Filed: Apr. 16, 2014

(30) Foreign Application Priority Data
Oct. 21, 2013 (KR) 10-2013-0125239

(51) Int. Cl. G06K 9/32; G06K 9/46

(52) U.S. Cl. CPC G06K 9/325; G06K 9/46
USPC 382/105

(57) ABSTRACT

Provided is an apparatus and method for detecting a vehicle number plate that may determine whether an input image includes a number plate, based on an optimal feature to be used to determine whether the input image includes a number plate.

### CROSS-REFERENCE TO RELATED APPLICATION

This application claims the benefit of Korean Patent Application No. 10-2013-0125239, filed on Oct. 21, 2013, in the Korean Intellectual Property Office, the disclosure of which is incorporated herein by reference.

### BACKGROUND

1. Field of the Invention

The present invention relates to an apparatus and method for detecting a vehicle number plate, and more particularly, to an apparatus and method for detecting a vehicle number plate that may determine whether an input image includes a number plate, based on an optimal feature to be used to determine whether the input image includes a number plate so that a vehicle number plate may be detected accurately although a portion of the number plate is obscured or distorted by light, illumination, contamination, and physical damage.

2. Description of the Related Art

With a rapid increase in a number of automobiles, a significance of technology for recognizing unique information such as, a number plate, used to identify an automobile is increasing. Many conventional technologies for recognizing a number plate in a vehicle image acquired from an image acquiring apparatus, for example, a closed-circuit television (CCTV), have been introduced, commercialized, and utilized in fields related to automobiles, for example, criminal vehicle control, a self parking system, and a driverless vehicle.

To recognize a vehicle number plate in an image, detection of a position of a number plate present in the image may be significant. Conventional technologies for detecting a number plate use edge, brightness, and color information of a number plate.

However, in the method using the edge or the brightness information of the number plate, detection of the position of the number plate may be difficult when a portion of the number plate is obscured or distorted by a rapid change in brightness in the number plate caused by light or illumination, contamination on the number plate, or physical damage. In addition, when the color information is used, the technologies may not be applicable to an infrared image or an image acquired at night.

### SUMMARY

An aspect of the present invention provides an apparatus and method for detecting a vehicle number plate that may detect a vehicle number plate accurately although a portion of the number plate is obscured or distorted by light, illumination, contamination, and physical damage.

Another aspect of the present invention also provides an apparatus and method for detecting a vehicle number plate that may detect a vehicle number plate accurately based on an optimal feature to be used to determine whether an input image includes a number plate.

According to an aspect of the present invention, there is provided an apparatus for detecting a vehicle number plate, the apparatus including an image acquirer to acquire an input image, a learner to provide an optimal feature to be used to determine whether the input image includes a number plate, and a number plate detector to determine, based on the optimal feature, whether the input image includes a number plate.

The learner may determine the optimal feature based on at least one number plate learning image in which a number plate is included, and at least one non-number plate learning image in which a number plate is not included.

The learner may include an optimal boundary value calculator to calculate a reference feature value based on a feature of a first feature area corresponding to a portion or an entirety of the at least one number plate learning image, and a feature of a second feature area corresponding to a portion of an entirety of the at least one non-number plate learning image, a minimum error feature area extractor to determine, based on the reference feature value, whether the at least one number plate learning image and the at least one non-number plate learning image include a number plate, identify, in the at least one number plate learning image, a first feature area which minimizes an error in the determining, and extract the identified first feature area as a minimum error feature area, and an optimal feature determiner to determine a feature of the extracted minimum error feature area to be the optimal feature.

The learner may further include a feature area feature extractor to convert the first feature area to a first grayscale image, convert the first grayscale image to a second grayscale image of a lower level by changing a pixel value of a pixel in the first grayscale image using a pixel value of an adjacent pixel of the pixel, and extract the feature of the first feature area using a histogram of the second grayscale image, and to convert the second feature area to a third grayscale image, convert the third grayscale image to a fourth grayscale image of a lower level by changing a pixel value of a pixel in the third grayscale image using a pixel value of an adjacent pixel of the pixel, and extract the feature of the second feature area using a histogram of the fourth grayscale image.

The learner may further include a weight changer to change a weight of the first feature area based on the error in the determining performed by the minimum error feature area extractor, and the minimum error feature area extractor may re-identify a first feature area that minimizes the error in view of the changed weight, and extract the re-identified first feature area as the minimum error feature area.

The reference feature value may be calculated based on the first feature area of the at least one number plate learning image and the second feature area of the at least one non-number plate learning image.

The reference feature value may be calculated based on a histogram value with respect to the first feature area of the at least one number plate learning image and a histogram value with respect to the second feature area of the at least one non-number plate learning image.

The number plate detector may include a candidate image feature extractor to extract a feature of a candidate image corresponding to a portion or an entirety of the input image, a feature comparator to compare the extracted feature to the optimal feature, and a determiner to determine whether the input image includes a number plate, based on a result of the comparing.

The candidate image feature extractor may convert the candidate image to a fifth grayscale image, convert the fifth grayscale image to a sixth grayscale image of a lower level by changing a pixel value of a pixel in the fifth grayscale image using a pixel value of an adjacent pixel of the pixel, and extract the feature of the candidate image using a histogram of a predetermined area in the sixth grayscale image, and the predetermined area may be determined by the learner.

The apparatus may further include a pre-processor to perform image pre-processing with respect to the acquired input image, and transmit the pre-processed input image to the number plate detector, and a post-processor to calculate a position of a number plate in the acquired input image based on the image pre-processing.

According to another aspect of the present invention, there is also provided a method of detecting a vehicle number plate, the method including acquiring and pre-processing an input image, determining an optimal feature to be used to determine whether the input image includes a number plate, based on at least one number plate learning image in which a number plate is included, and at least one non-number plate learning image in which a number plate is not included, and determining, based on the optimal feature, whether the input image includes a number plate.

The determining of the optimal feature may include calculating a reference feature value based on a feature of a first feature area corresponding to a portion or an entirety of the at least one number plate learning image, and a feature of a second feature area corresponding to a portion of the entirety of the at least one non-number plate learning image, determining, based on the reference feature value, whether the at least one number plate learning image and the at least one non-number plate learning image include a number plate, identifying, in the at least one number plate learning image, a first feature area which minimizes an error in the determining, and extracting the identified first feature area as a minimum error feature area, and determining a feature of the extracted minimum error feature area to be the optimal feature.

The determining of the optimal feature may further include changing a weight of the first feature area based on the error in the determining, and the extracting may include re-identifying a first feature area that minimizes the error in view of the changed weight, and extracting the re-identified first feature area as the minimum error feature area.

The reference feature value may be calculated based on the first feature area of the at least one number plate learning image and the second feature area of the at least one non-number plate learning image.

The determining of whether the input image includes a number plate may include extracting a feature of a candidate image corresponding to a portion or the entirety of the input image, comparing the extracted feature to the optimal feature, and determining whether the input image includes a number plate, based on a result of the comparing.

The extracting may include converting the candidate image to a fifth grayscale image, converting the fifth grayscale image to a sixth grayscale image of a lower level by changing a pixel value of a pixel in the fifth grayscale image using a pixel value of an adjacent pixel of the pixel, and extracting the feature of the candidate image using a histogram of a predetermined area in the sixth grayscale image, and the predetermined area may be determined in the determining of the optimal feature.

According to still another aspect of the present invention, there is also provided a learning method for detection of a vehicle number plate, the method including extracting a feature of a first feature area corresponding to a portion or the entirety of at least one number plate learning image in which a number plate is included, and a feature of a second feature area corresponding to a portion of the entirety of at least one non-number plate learning image in which a number plate is not included, calculating a reference feature value based on the feature of the first feature area and the feature of the second feature area, determining, based on the reference feature value, whether the at least one number plate learning image and the at least one non-number plate learning image include a number plate, identifying, in the at least one number plate learning image, a first feature area that minimizes an error in the determining, and extracting the identified first feature area as a minimum error feature area, and determining a feature of the extracted minimum error feature area to be an optimal feature.

The extracting of the feature of the first feature area and the feature of the second feature area may include converting the first feature area to a first grayscale image, converting the first grayscale image to a second grayscale image of a lower level by changing a pixel value of a pixel in the first grayscale image using a pixel value of an adjacent pixel of the pixel, and extracting the feature of the first feature area using a histogram of the second grayscale image, and converting the second feature area to a third grayscale image, converting the third grayscale image to a fourth grayscale image of a lower level by changing a pixel value of a pixel in the third grayscale image using a pixel value of an adjacent pixel of the pixel, and extracting the feature of the second feature area using a histogram of the fourth grayscale image.

The method may further include changing a weight of the first feature area based on the error in the determining performed during the extracting of the identified first feature area as the minimum error feature area, and the extracting of the identified first feature area as the minimum error feature area may include re-identifying a first feature area that minimizes the error in view of the changed weight, and extracting the re-identified first feature area as the minimum error feature area.

The reference feature value may be calculated based on the first feature area of the at least one number plate learning image and the second feature area of the at least one non-number plate learning image.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating an example of an apparatus for detecting a vehicle number plate;

FIG. 2 is a block diagram illustrating an example of a number plate detector in an apparatus for detecting a vehicle number plate;

FIG. 3 is a diagram illustrating a method of extracting a feature from an image;

FIG. 4 is a block diagram illustrating an example of a learner in an apparatus for detecting a vehicle number plate;

FIG. 5 is a flowchart illustrating an example of a method of detecting a vehicle number plate; and

FIG. 6 is a flowchart illustrating an example of a learning method for detection of a vehicle number plate.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

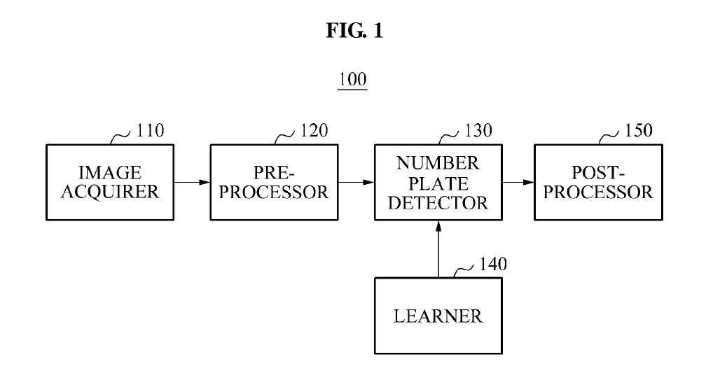

FIG. 1 is a block diagram illustrating an example of an apparatus 100 for detecting a vehicle number plate.

Referring to FIG. 1, the apparatus 100 for detecting a vehicle number plate may include an image acquirer 110, a pre-processor 120, a number plate detector 130, a learner 140, and a post-processor 150.

The image acquirer 110 may acquire an input image to recognize a number plate from an image acquiring apparatus. The image acquiring apparatus refers to an apparatus that may acquire an image, and may include, for example, a closed-circuit television (CCTV), a digital camera, and an infrared camera. The acquired input image may correspond to a digital image, and include a color image, a grayscale image, and an infrared image. In addition, the acquired input image may include a still image and a moving image.

The pre-processor 120 may perform image pre-processing with respect to the acquired input image, and transmit the pre-processed input image to the number plate detector 130. The pre-processor 120 may perform the image pre-processing before transmitting the acquired input image to the number plate detector 130. The pre-processor 120 may remove noise that may affect a detection performance, extract a feature, convert the input image to an image of a unified image format for comparison, or scale the input image at a predetermined ratio based on a size of a target to be recognized. The pre-processor 120 may change, for example, a size and a color space of the acquired input image.

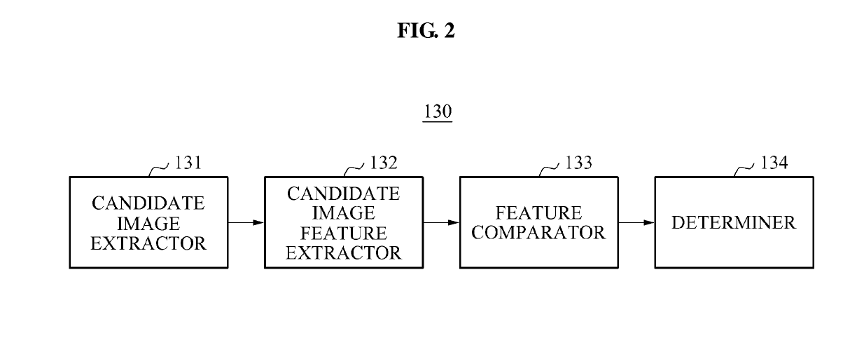

The number plate detector 130 may determine whether the input image includes a number plate, using an optimal feature determined by the learner 140. An example of the number plate detector 130 will be described with reference to FIG. 2.

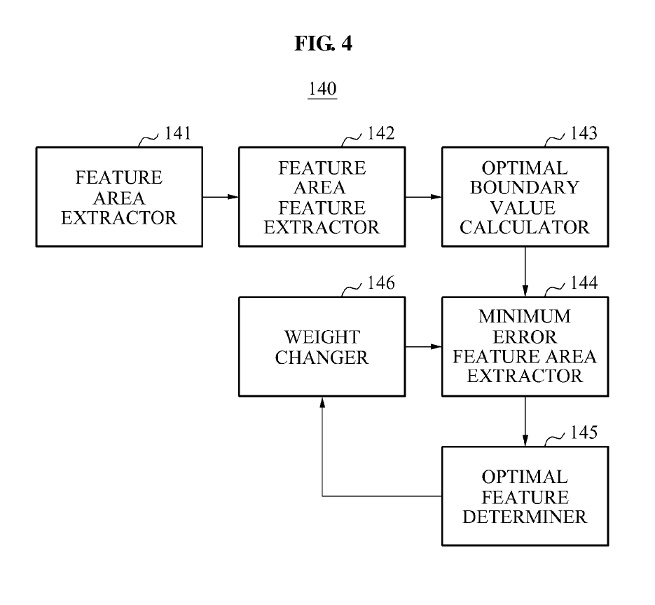

The learner 140 may provide, to the number plate detector 130, an optimal feature to be used to determine whether the input image includes a number plate. The learner 140 may determine the optimal feature based on at least one number plate learning image in which a number plate is included, and at least one non-number learning image in which a number plate is not included. An example of the learner 140 will be described with reference to FIG. 4.

The post-processor 150 may finally process a result of the detecting performed by the number plate detector 130 to be suitable for a purpose. The post-processor 150 may calculate a position of a number plate in the acquired input image based on the image pre-processing performed by the pre-processor 120.

FIG. 2 is a block diagram illustrating an example of the number plate detector 130 of FIG. 1.

Referring to FIG. 2, the number plate detector 130 may include a candidate image extractor 131, a candidate image feature extractor 132, a feature comparator 133, and a determiner 134. The number plate detector 130 may determine whether an input image includes a number plate, using an optimal feature determined by the learner 140. In this example, that the input mage includes a number plate refers to that the input image includes a number plate shaped-image.

The candidate image extractor 131 may extract, from the acquired input image, a candidate image in which a number plate is possibly included. In a general case in which an area including a number plate is unknown in the acquired input image, the candidate image extractor 131 may extract images of all areas in the acquired input image as candidate images. The candidate image refers to an image of a candidate area in which a number plate is possibly included, in the input image acquired by the image acquirer 110, and may correspond to a portion or an entirety of the input image. However, when an area including a number plate is predictable, the candidate image extractor 131 may extract the candidate image within a predicted area.

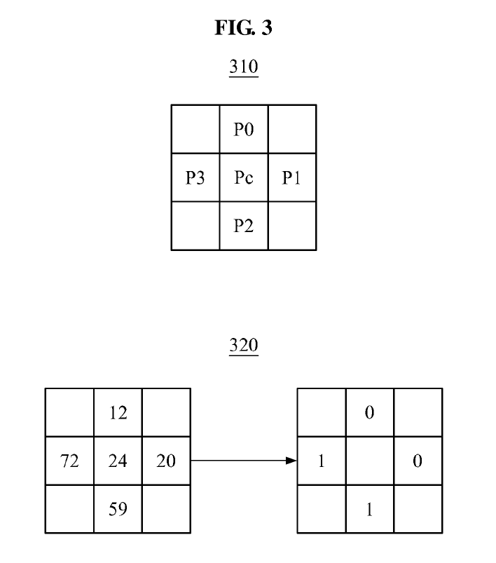

The candidate image feature extractor 132 may extract a feature of the candidate image corresponding to a portion or the entirety of the input image. An example of a method of extracting the feature of the candidate image will be described with reference FIG. 3.

The feature comparator 133 may compare the feature of the candidate image extracted by the candidate image feature extractor 132 to the optimal feature determined by the learner 140.

The determiner 134 may determine whether the candidate image corresponds to a number plate image, based on a result of the comparing performed by the feature comparator 133. The determiner 134 may determine whether the input image includes a number plate, based on the result of the comparing performed by the feature comparator 133.

FIG. 3 is a diagram illustrating a method of extracting a feature from an image.

Referring to FIG. 3, a method of extracting a feature of a candidate image performed by the candidate image feature extractor 132 is illustrated.

A candidate image 310 may be converted to a fifth grayscale image.

The fifth grayscale image may be converted to a sixth grayscale image of a lower level, in operation 320. A pixel value of a pixel Pc in the fifth grayscale image may be converted using a pixel value of an adjacent pixel of the pixel Pc in the fifth grayscale image. The adjacent pixel of the pixel Pc in the fifth grayscale image may include pixels P0, P1, P2, and P3 disposed on upper, lower, left, and right sides of the pixel Pc. For example, a fifth grayscale image of 256 levels may be converted to a sixth grayscale image of 16 levels. As another example, the fifth grayscale image of 256 levels may be converted to a sixth grayscale of 59 levels. Hereinafter, a case in which the fifth grayscale image of 256 levels is converted to the sixth grayscale image of 16 levels will be described. The conversion to the sixth grayscale image of 16 levels may be performed using Equation 1.

$$\overline{Pc} = {\sum }_{n = 0}^{n = 3} t ( Pn - Pc ) * {2}^{n} \\ t ( x ) = \{ \begin{matrix}1 , & if x \geq 0 \\ 0 , & otherwise\end{matrix} \qquad [ Equation 1 ]$$

In Equation 1, Pc denotes a pixels to be converted, Pn denotes an adjacent pixel of the pixel to be converted, and P̅c̅ denotes a resulting pixel.

A pixel value of Pc may correspond to 24, a pixel value of P0 may correspond to 12, a pixel value of P1 may correspond to 20, a pixel value of P2 may correspond to 59, and a pixel value of P3 may correspond to 72. In this example, Pc may be converted as expressed by Equation 2.

$$\overline{Pc} = t ( P 0 - Pc ) * {2}^{0} + t ( P 1 - Pc ) * {2}^{1} + t ( P 2 - Pc ) * {2}^{2} + t ( P 3 - Pc ) * {2}^{3} \\ \overline{Pc} = 0 * {2}^{0} + 0 * {2}^{1} + 1 * {2}^{2} + 1 * {2}^{3} = 12 \qquad [ Equation 2 ]$$

As described above, the pixel Pc having the pixel value of 24 may be converted to the pixel P̅c̅ having a pixel value of 12.

A feature of the candidate image 310 may be extracted using a histogram of a predetermined area in the sixth grayscale image. The predetermined area may be determined by the learner 140. The predetermined area may correspond to the optimal feature determined by the learner 140.

The method of extracting the feature of the candidate area may be applied to a method of extracting a feature of a feature area performed by a feature area feature extractor 142 included in the learner 140.

For example, the feature area feature extractor 142 may convert a first feature area, corresponding to a portion or an entirety of at least one number plate learning image, to a first grayscale image, convert the first grayscale image to a second grayscale image of a lower level by changing a pixel value of a pixel in the first grayscale image using a pixel value of an adjacent pixel of the pixel, and extract a feature of the first feature area using a histogram of the second grayscale image.

The feature area feature extractor 142 may convert a second feature area, corresponding to a portion or an entirety of at least one non-number plate learning image, to a third grayscale image, convert the third grayscale image to a fourth grayscale image of a lower level by changing a pixel value of a pixel in the third grayscale image using a pixel value of an adjacent pixel of the pixel, and extract a feature of the second feature area using a histogram of the fourth grayscale image.

FIG. 4 is a block diagram illustrating an example of the learner 140 of FIG. 1.

Referring to FIG. 4, the learner 140 may include a feature area extractor 141, a feature area feature extractor 142, an optimal boundary value calculator 143, a minimum error feature area extractor 144, an optimal feature determiner 145, and a weight changer 146. The learner 140 may provide, to the number plate detector 130, an optimal feature to be used to determine whether an input image includes a number plate. The learner 140 may determine the optimal feature based on at least one number plate learning image in which a number plate is included, and at least one non-number plate learning image in which a number plate is not included.

The feature area extractor 141 may extract a feature area from a learning image to extract a feature of a number plate. For example, the feature area extractor 141 may extract all possible areas from a learning image as candidate areas to calculate a histogram for extracting a feature of a number plate image. The learning image refers to an image used to extract a feature of a number plate, and may include a number plate learning image in which a number plate is included, and a non-number plate learning image in which a number plate is not included. The feature area refers to an area corresponding to a portion or an entirety of a learning image used to extract the feature of the number plate image, and may include all areas having the potential for being optimal features based on a determination of the learner 140.

A total number of cases in which a feature area may be extracted from a learning image may be calculated as expressed by Equation 3.

$$N = {\sum }_{w = 1}^{W} w \times {\sum }_{h = 1}^{H} h \qquad [ Equation 3 ]$$

In Equation 3, W denotes a width of the learning image, H denotes a height of the learning image, w denotes a width of the feature area, h denotes a height of the feature area, and N denotes the total number of cases for feature areas expressed by w×h.

The feature area feature extractor 142 may extract a feature of the feature area. The feature area feature extractor 142 may convert a first feature area, corresponding to a portion or the entirety of at least one number plate learning image, to a first grayscale image, convert the first grayscale image to a second grayscale image of a lower level by changing a pixel value of a pixel in the first grayscale image using a pixel value of an adjacent pixel of the pixel, and extract the feature of the first feature area using a histogram of the second grayscale image. In addition, the feature area feature extractor 142 may convert a second feature area, corresponding to a portion or the entirety of at least one non-number plate learning image, to a third grayscale image, convert the third grayscale image to a fourth grayscale image of a lower level by changing a pixel value of a pixel in the third grayscale image using a pixel value of an adjacent pixel of the pixel, and extract a feature of the second feature area using a histogram of the fourth grayscale image.

The descriptions provided with reference to FIG. 3 may be applied to the method of extracting the feature of the feature area performed by the feature area feature extractor 142 and thus, duplicated descriptions will be omitted for conciseness.

The optimal boundary value calculator 143 may calculate a reference feature value that determines whether the input image includes a number plate, based on the feature extracted by the feature area feature extractor 142. The optimal boundary value calculator 143 may calculate the reference feature value based on the feature of the first feature area and the feature of the second feature area. The reference feature value may correspond to an optimal boundary value.

The reference feature value may be calculated based on the first feature area of the at least one number plate learning image and the second feature area of the at least one non-number plate learning image. The reference feature value may be calculated based on a histogram value with respect to the first feature area of the at least one number plate learning image and a histogram value with respect to the second feature area of the at least one non-number plate learning image. The reference feature value may correspond to a median of an average of the histogram value with respect to the first feature area of the at least one number plate learning image and an average of the histogram value with respect to the second feature area of the at least one non-number plate learning image. The reference feature value may correspond to an optimal boundary value.

The minimum error feature area extractor 144 may extract, as a minimum error feature area, a feature area that minimizes an error when the number plate learning image and the non-number plate learning image are distinguished using the reference feature value calculated by the optimal boundary value calculator 143. The minimum error feature area extractor 144 may determine, based on the reference feature value, whether the at least one number plate learning image and the at least one non-number plate learning image include a number plate, identify, in the at least one number plate learning image, a first feature area which minimizes an error in the determining, and extract the identified first feature area as the minimum error feature area. The minimum error feature area extractor 144 may extract, as the minimum error feature area, a feature area that minimizes an accumulated error when the number plate learning image and the non-number plate learning image are distinguished using the reference feature value.

The optimal feature determiner 145 may determine a feature of the extracted minimum error feature area of the at least one number plate learning image to be the optimal feature. The optimal feature may include the feature of the minimum error feature area and the reference feature value.

The weight changer 146 may change a weight of the first feature area based on the error in the determining performed by the minimum error feature area extractor 144. The minimum error feature area extractor 144 may re-identify a first feature area that minimizes the error in view of the weight changed by the weight changer 146, and extract the re-identified first feature area as the minimum error feature area. The weight changer 146 may repeatedly change the weight until a minimum error exceeds a predetermined value such that a feature of an extracted minimum error feature area is unusable as a feature that detects a number plate.

The learner 140 may employ a method of determining an optimal feature. The method of determining an optimal feature may correspond to a method of configuring a strong classifier with a high detection performance through a linear combination of at least one weak classifier. The optimal feature determined by the learner 160 may correspond to a weak classifier that minimizes an error, among weak classifiers expressed by Equation 4.

$$h ( x , f , p , θ ) = \{ \begin{matrix}1 & if pf ( x ) < p θ \\ 0 & otherwise\end{matrix} \qquad [ Equation 4 ]$$

In Equation 4, x denotes an input learning image, f denotes a function to obtain a feature of the learning image x and may have the same meaning as f(x). θ denotes a reference feature value to be used to determine whether the learning image includes a number plate. p denotes a value, for example, a parity or direction information, to determine whether an image including a number plate has a value greater than or less than the reference feature value. In addition, h(x, f, p, θ) denotes a weak classifier function h including four factors (x, f, p, θ).

In Equation 4, the reference feature value expressed using θ may be a significant value that affects a performance of the weak classifier. In learning, when a feature by a function f′ is extracted using the number plate learning image and the non-number plate learning image, the learning may be performed under an assumption that whether the learning image includes a number plate may be determined based on the reference feature value θ. The reference feature value θ may be determined to be a median of an average of the histogram value with respect to the first feature area of the at least one number plate learning image and an average of the histogram value with respect to the second feature area of the at least one non-number plate learning image.

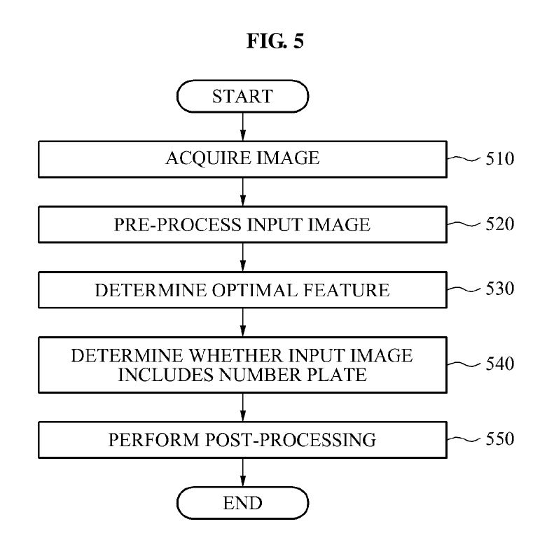

FIG. 5 is a flowchart illustrating an example of a method of detecting a vehicle number plate.

Referring to FIG. 5, in operation 510, an apparatus for detecting a vehicle number plate, hereinafter, the detecting apparatus, may acquire an input image to recognize a number plate from an image acquiring apparatus. The image acquiring apparatus refers to an apparatus that may acquire an image, and may include, for example, a CCTV, a digital camera, and an infrared camera. The acquired input image may correspond to a digital image, and include a color image, a grayscale image, and an infrared image. In addition, the acquired input image may include a still image and a moving image.

In operation 520, the detecting apparatus may pre-process the acquired input image. The detecting apparatus may perform image pre-processing before determining whether the acquired input image includes a number plate. The image pre-processing may include removing noise that may affect a detection performance, extracting a feature, converting the input image to an image of a unified image format for comparison, or scaling the input image at a predetermined ratio based on a size of a target to be recognized. The detecting apparatus may change, for example, a size and a color space of the acquired input image.

In operation 530, the detecting apparatus may determine an optimal feature to be used to determine whether the input image includes a number plate, based on at least one number plate learning image in which a number plate is included, and at least one non-number plate learning image in which a number plate is not included. The descriptions provided with reference to FIG. 4 may be applied to the method of determining the optimal feature performed by the detecting apparatus and thus, duplicated descriptions will be omitted for conciseness.

In operation 540, the detecting apparatus may determine, based on the optimal feature, whether the input image includes a number plate. The detecting apparatus may change a weight of a first feature area based on an error in the determining, re-identify a first feature area that minimizes the error in view of the changed weight, and extract the re-identified first feature area as a minimum error feature area. The detecting apparatus may extract a feature of a candidate image corresponding to a portion or the entirety of the input image, compare the extracted feature to the optimal feature, and determine whether the input image includes a number plate, based on a result of the comparing.

The descriptions provided with reference to FIG. 2 may be applied to the method of determining whether the input image includes a number plate performed by the detecting apparatus and thus, duplicated descriptions will be omitted for conciseness.

In operation 550, the detecting apparatus may finally process a result of the detecting to be suitable for a purpose. The detecting apparatus may calculate a position of a number plate in the acquired input image based on the image pre-processing.

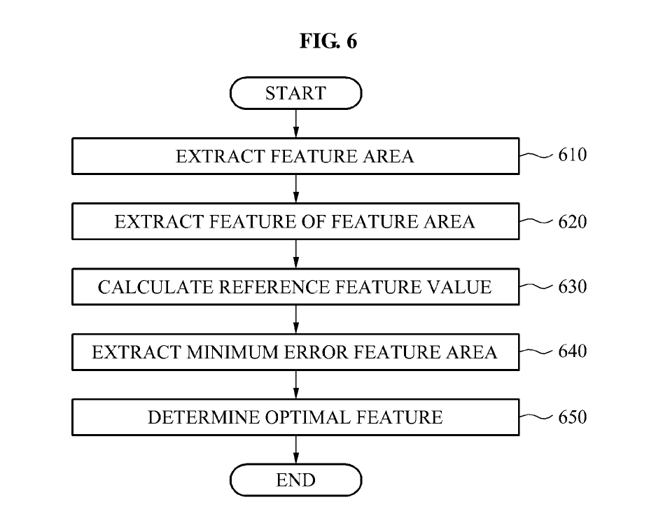

FIG. 6 is a flowchart illustrating an example of a learning method for detection of a vehicle number plate.

Referring to FIG. 6, in operation 610, an apparatus for detecting a vehicle number plate, hereinafter, the detecting apparatus, may extract a feature area from a learning image to extract a feature of a number plate. For example, the detecting apparatus may extract all possible areas from a learning image as candidate areas to calculate a histogram for extracting a feature of a number plate image. The learning image refers to an image used to extract a feature of a number plate, and may include a number plate learning image in which a number plate is included, and a non-number plate learning image in which a number plate is not included. The feature area refers to an area corresponding to a portion or an entirety of a learning image used to extract the feature of the number plate image, and may include all potential areas to be used as optimal features.

In operation 620, the detecting apparatus may extract a feature of a first feature area, corresponding to a portion or an entirety of at least one number plate learning image in which a number plate is included, and a feature of a second feature area, corresponding to a portion or an entirety of at least one non-number plate learning image in which a number plate is not included. The detecting apparatus may convert the first feature area to a first grayscale image, convert the first grayscale image to a second grayscale image of a lower level by changing a pixel value of a pixel in the first grayscale image using a pixel value of an adjacent pixel of the pixel, and extract the feature of the first feature area using a histogram of the second grayscale image, and may convert the second feature area to a third grayscale image, convert the third grayscale image to a fourth grayscale image of a lower level by changing a pixel value of a pixel in the third grayscale image using a pixel value of an adjacent pixel of the pixel, and extract the feature of the second feature area using a histogram of the fourth grayscale image.

In operation 630, the detecting apparatus may calculate a reference feature value based on the feature of the first feature area and the feature of the second feature area. The detecting apparatus may calculate the reference feature value based on the feature of the first feature area corresponding to a portion or the entirety of the at least one number plate learning image and the feature of the second feature area corresponding to a portion or the entirety of the at least one non-number plate learning image. The reference feature value may correspond to an optimal boundary value.

The reference feature value may be calculated based on the first feature area of the at least one number plate learning image and the second feature area of the at least one non-number plate learning image. The reference feature value may be calculated based on a histogram value with respect to the first feature area of the at least one number plate learning image and a histogram value with respect to the second feature area of the at least one non-number plate learning image. The reference feature value may correspond to a median of an average of the histogram value with respect to the first feature area of the at least one number plate learning image and an average of the histogram value with respect to the second feature area of the at least one non-number plate learning image. The reference feature value may correspond to an optimal boundary value.

In operation 640, the detecting apparatus may determine, based on the reference feature value, whether the at least one number plate learning image and the at least one non-number plate learning image include a number plate, identify, in the at least one number plate learning image, a first feature area which minimizes an error in the determining, and extract the identified first feature area as the minimum error feature area. The detecting apparatus may extract, as the minimum error feature area, a feature area that minimizes an accumulated error when the number plate learning image and the non-number plate learning image are distinguished using the reference feature value.

In operation 650, the detecting apparatus may determine a feature of the extracted minimum error feature area of the at least one number plate learning image to be the optimal feature. The optimal feature may include the feature of the minimum error feature area and the reference feature value.

The detecting apparatus may change a weight of the first feature area based on the error in the determining performed in the extracting of the identified first feature area as the minimum error feature area. When the weight of the first feature area is changed, the detecting apparatus may re-identify a first feature area that minimizes the error in view of the changed weight, and extract the re-identified first feature area as the minimum error feature area. A feature of the newly extracted minimum error feature area may be determined to be the optimal feature. The detecting apparatus may repeatedly change the weight until a minimum error exceeds a predetermined value such that a feature of an extracted minimum error feature area is unusable as a feature that detects a number plate.

The descriptions provided with reference to FIG. 4 may be applied to the learning method for detection of a vehicle number plate and thus, duplicated descriptions will be omitted for conciseness.

According to exemplary embodiments, a vehicle number plate may be detected accurately using an optimal feature to be used to determine whether an input image includes a number plate.

According to exemplary embodiments, a vehicle number plate may be detected accurately although a portion of the number plate is obscured or distorted by light, illumination, contamination, and physical damage.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for detecting a vehicle number plate, the apparatus comprising:
an image acquirer to acquire an input image;
a learner to provide an optimal feature to be used to determine whether the input image includes a number plate; and
a number plate detector to determine, based on the optimal feature, whether the input image includes a number plate.

2. The apparatus of claim 1, wherein the learner determines the optimal feature based on at least one number plate learning image in which a number plate is included, and at least one non-number plate learning image in which a number plate is not included.

3. The apparatus of claim 2, wherein the learner comprises;
an optimal boundary value calculator to calculate a reference feature value based on a feature of a first feature area corresponding to a portion or an entirety of the at least one number plate learning image, and a feature of a second feature area corresponding to a portion of an entirety of the at least one non-number plate learning image;
a minimum error feature area extractor to determine, based on the reference feature value, whether the at least one number plate learning image and the at least one non-number plate learning image include a number plate, identify, in the at least one number plate learning image, a first feature area which minimizes an error in the determining, and extract the identified first feature area as a minimum error feature area; and
an optimal feature determiner to determine a feature of the extracted minimum error feature area to be the optimal feature.

4. The apparatus of claim 3, wherein the learner further comprises:
a feature area feature extractor to convert the first feature area to a first grayscale image, convert the first grayscale image to a second grayscale image of a lower level by changing a pixel value of a pixel in the first grayscale image using a pixel value of an adjacent pixel of the pixel, and extract the feature of the first feature area using a histogram of the second grayscale image, and to convert the second feature area to a third grayscale image, convert the third grayscale image to a fourth grayscale image of a lower level by changing a pixel value of a pixel in the third grayscale image using a pixel value of an adjacent pixel of the pixel, and extract the feature of the second feature area using a histogram of the fourth grayscale image.

5. The apparatus of claim 3, wherein the learner further comprises:
a weight changer to change a weight of the first feature area based on the error in the determining performed by the minimum error feature area extractor,
wherein the minimum error feature area extractor re-identifies a first feature area that minimizes the error in view of the changed weight, and extracts the re-identified first feature area as the minimum error feature area.

6. The apparatus of claim 3, wherein the reference feature value is calculated based on the first feature area of the at least one number plate learning image and the second feature area of the at least one non-number plate learning image.

7. The apparatus of claim 6, wherein the reference feature value is calculated based on a histogram value with respect to the first feature area of the at least one number plate learning image and a histogram value with respect to the second feature area of the at least one non-number plate learning image.

8. The apparatus of claim 1, wherein the number plate detector comprises:
a candidate image feature extractor to extract a feature of a candidate image corresponding to a portion or the entirety of the input image;
a feature comparator to compare the extracted feature to the optimal feature; and
a determiner to determine whether the input image includes a number plate, based on a result of the comparing.

9. The apparatus of claim 8, wherein the candidate image feature extractor converts the candidate image to a fifth grayscale image, converts the fifth grayscale image to a sixth grayscale image of a lower level by changing a pixel value of a pixel in the fifth grayscale image using a pixel value of an adjacent pixel of the pixel, and extracts the feature of the candidate image using a histogram of a predetermined area in the sixth grayscale image,
wherein the predetermined area is determined by the learner.

10. The apparatus of claim 1, further comprising:
a pre-processor to perform image pre-processing with respect to the acquired input image, and transmit the pre-processed input image to the number plate detector; and
a post-processor to calculate a position of a number plate in the acquired input image based on the image pre-processing.

11. A method of detecting a vehicle number plate, the method comprising:
acquiring and pre-processing an input image;
determining an optimal feature to be used to determine whether the input image includes a number plate, based on at least one number plate learning image in which a number plate is included, and at least one non-number plate learning image in which a number plate is not included; and
determining, based on the optimal feature, whether the input image includes a number plate.

12. The method of claim 11, wherein the determining of the optimal feature comprises:
calculating a reference feature value based on a feature of a first feature area corresponding to a portion or an entirety of the at least one number plate learning image, and a feature of a second feature area corresponding to a portion of an entirety of the at least one non-number plate learning image;
determining, based on the reference feature value, whether the at least one number plate learning image and the at least one non-number plate learning image include a number plate, identifying, in the at least one number plate learning image, a first feature area which minimizes an error in the determining, and extracting the identified first feature area as a minimum error feature area; and
determining a feature of the extracted minimum error feature area to be the optimal feature.

13. The method of claim 12, wherein the determining of the optimal feature further comprises:
changing a weight of the first feature area based on the error in the determining,
wherein the extracting comprises re-identifying a first feature area that minimizes the error in view of the changed weight, and extracting the re-identified first feature area as the minimum error feature area.

14. The method of claim 12, wherein the reference feature value is calculated based on the first feature area of the at least one number plate learning image and the second feature area of the at least one non-number plate learning image.

15. The method of claim 11, wherein the determining of whether the input image includes a number plate comprises:
extracting a feature of a candidate image corresponding to a portion or the entirety of the input image;
comparing the extracted feature to the optimal feature; and
determining whether the input image includes a number plate, based on a result of the comparing.

16. The method of claim 15, wherein the extracting comprises converting the candidate image to a fifth grayscale image, converting the fifth grayscale image to a sixth grayscale image of a lower level by changing a pixel value of a pixel in the fifth grayscale image using a pixel value of an adjacent pixel of the pixel, and extracting the feature of the candidate image using a histogram of a predetermined area in the sixth grayscale image,
wherein the predetermined area is determined in the determining of the optimal feature.

17. A learning method for detection of a vehicle number plate, the method comprising:
extracting a feature of a first feature area corresponding to a portion or an entirety of at least one number plate learning image in which a number plate is included, and a feature of a second feature area corresponding to a portion of an entirety of at least one non-number plate learning image in which a number plate is not included;
calculating a reference feature value based on the feature of the first feature area and the feature of the second feature area;
determining, based on the reference feature value, whether the at least one number plate learning image and the at least one non-number plate learning image include a number plate, identifying, in the at least one number plate learning image, a first feature area that minimizes an error in the determining, and extracting the identified first feature area as a minimum error feature area; and
determining a feature of the extracted minimum error feature area to be an optimal feature.

18. The method of claim 17, wherein the extracting of the feature of the first feature area and the feature of the second feature area comprises:
converting the first feature area to a first grayscale image, converting the first grayscale image to a second grayscale image of a lower level by changing a pixel value of a pixel in the first grayscale image using a pixel value of an adjacent pixel of the pixel, and extracting the feature of the first feature area using a histogram of the second grayscale image; and
converting the second feature area to a third grayscale image, converting the third grayscale image to a fourth grayscale image of a lower level by changing a pixel value of a pixel in the third grayscale image using a pixel value of an adjacent pixel of the pixel, and extracting the feature of the second feature area using a histogram of the fourth grayscale image.

19. The method of claim 17, further comprising:
changing a weight of the first feature area based on the error in the determining performed during the extracting of the identified first feature area as the minimum error feature area,
wherein the extracting of the identified first feature area as the minimum error feature area comprises re-identifying a first feature area that minimizes the error in view of the changed weight, and extracting the re-identified first feature area as the minimum error feature area.

20. The method of claim 17, wherein the reference feature value is calculated based on the first feature area of the at least one number plate learning image and the second feature area of the at least one non-number plate learning image.
